(19) United States
(12) Patent Application Publication
(10) Pub. No.: US 2018/0165717 A1
(43) Pub. Date: Jun. 14, 2018

(54) Keyword Bidding based on Search Traffic on Online Social Networks

(71) Applicant: Facebook, Inc., Menlo Park, CA (US)

(72) Inventors: Yaron Fidler, San Jose, CA (US); Ching-Chih Weng, Union City, CA (US); Yuyan Hu, Milpitas, CA (US); Shafqat Ahmed, San Francisco, CA (US)

(21) Appl. No.: 15/376,467

(22) Filed: Dec. 12, 2016

(51) Int. Cl. G06Q 30/02; G06F 17/30; G06Q 50/00

(52) U.S. Cl. CPC G06Q 30/0275; G06F 17/30867; G06Q 50/01; G06Q 30/0256; G06F 17/30985

(57) ABSTRACT

In one embodiment, a method includes accessing search traffic data internal to a social-networking system, the internal search traffic data comprising historical search volume for search terms; identifying qualifying keywords based on the internal search traffic data, wherein the internal search traffic data for each qualifying keyword satisfies one or more of the following criteria: (1) a current search volume for the qualifying keyword is less than an upper threshold volume; (2) an overall rate of change in search volume during an overall timeframe is greater than a first threshold rate of change; and (3) a current rate of change in search volume during a current timeframe is greater than a second threshold rate of change, wherein the overall timeframe begins at a time preceding the current timeframe; and sending instructions for placing a bid on each qualifying keyword to a third-party system associated with an external search engine.

### TECHNICAL FIELD

This disclosure generally relates to performing searches for objects within a social-networking environment.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

### SUMMARY OF PARTICULAR EMBODIMENTS

In particular embodiments, the social-networking system may identify keywords to use in a search engine marketing campaign on a third-party advertising service such as GOOGLE ADWORDS. The social-networking system may receive many (e.g., 500 million) search queries every day. Search queries performed by users on the online social network may mirror search queries on third-party search engines such as GOOGLE. As an example and not by way of limitation, a spike in search traffic for a particular keyword (e.g., “jason paige”) may exist on both the social-networking system and a third-party search engine on the same day. The social-networking system, along with the vast majority of other advertisers, may not have full access to the (external) search data of the third-party search engine, but the social-networking system may have access to its own search data. Thus, the social-networking system can use the half-billion searches performed on its own website to approximate (or, in particular embodiments, predict) the search queries occurring on a third-party search engine. The social-networking system may use its own (internal) search data to identify qualifying keywords before the competition (e.g., other companies who wish to advertise on search-results pages for the same keywords). The social-networking system may then bid on those qualifying keywords in an online-advertising service (e.g., GOOGLE ADWORDS). Other advertisers may be unaware that the qualifying keywords have relatively high search volume because they do not have access to a large amount of search data like the social-networking system does. Thus, there may be low competition for qualifying keywords. Because there is low competition, qualifying keywords may be less expensive than other high-volume keywords.

To identify qualifying keywords, the social-networking system may access its internal search traffic data for many different keywords. The social-networking system may then analyze the search traffic data for each keyword to identify qualifying keywords whose search traffic data meets one or more of the following criteria: (1) a current search volume for the qualifying keyword is less than an upper threshold volume; (2) an overall rate of change in search volume during an overall timeframe is greater than a first threshold rate of change; or (3) a current rate of change in search volume during a current timeframe is greater than a second threshold rate of change. The social-networking system may identify many qualifying keywords that meet some or all of the above criteria. For each qualifying keyword, the social-networking system may send instructions for placing a bid on the qualifying keyword to an online advertising service (e.g., GOOGLE ADWORDS). This process may minimize interactions between the social-networking system and third-party systems associated with external search engines. This may decrease processing time on each party's respective servers as well as save memory space on each party's respective servers. Additionally, because the social-networking system uses internal search traffic data, the method and system described herein reduce latency between spikes in search traffic for various search terms and placing bids for those search terms. Another technical advantage of particular embodiments described herein may be to reduce the time required for monitoring third-party systems associated with external search engines. Instead of regularly sending requests for search data to a third-party system that produces search data analytics (e.g., GOOGLE TRENDS), the social-networking system may simply monitor its own internal search data and interact with a third-party system only when qualifying keywords are identified.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example search volume visualization for two example keywords.

FIG. 4 illustrates another example search volume visualization for an example keyword.

FIG. 5 illustrates an example method 500 for identifying qualifying keywords for use in an online marketing campaign.

FIG. 6 illustrates an example computer system.

### DESCRIPTION OF EXAMPLE EMBODIMENTS

### System Overview

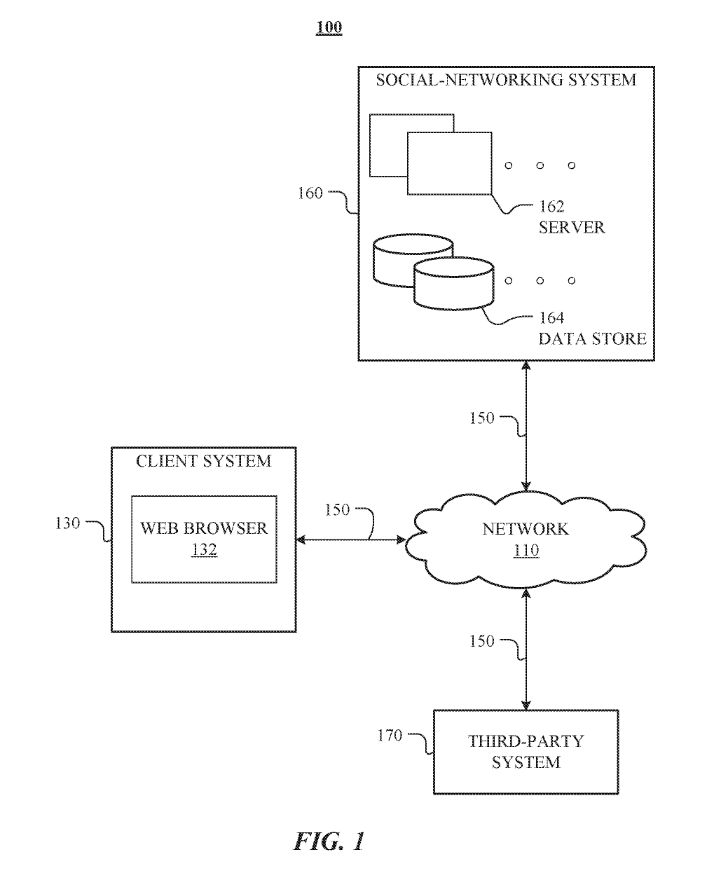

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of a client system 130, a social-networking system 160, a third-party system 170, and a network 110, this disclosure contemplates any suitable arrangement of a client system 130, a social-networking system 160, a third-party system 170, and a network 110. As an example and not by way of limitation, two or more of a client system 130, a social-networking system 160, and a third-party system 170 may be connected to each other directly, bypassing a network 110. As another example, two or more of a client system 130, a social-networking system 160, and a third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client systems 130, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130.

In particular embodiments, a client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 160 may be a network-addressable computing system that can host an online social network. The social-networking system 160 may generate, store, receive, and send social-networking data, such as, for example, user-profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132, or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a request received from a client system 130. Authorization servers may be used to enforce one or more privacy settings of the users of the social-networking system 160. A privacy setting of a user determines how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

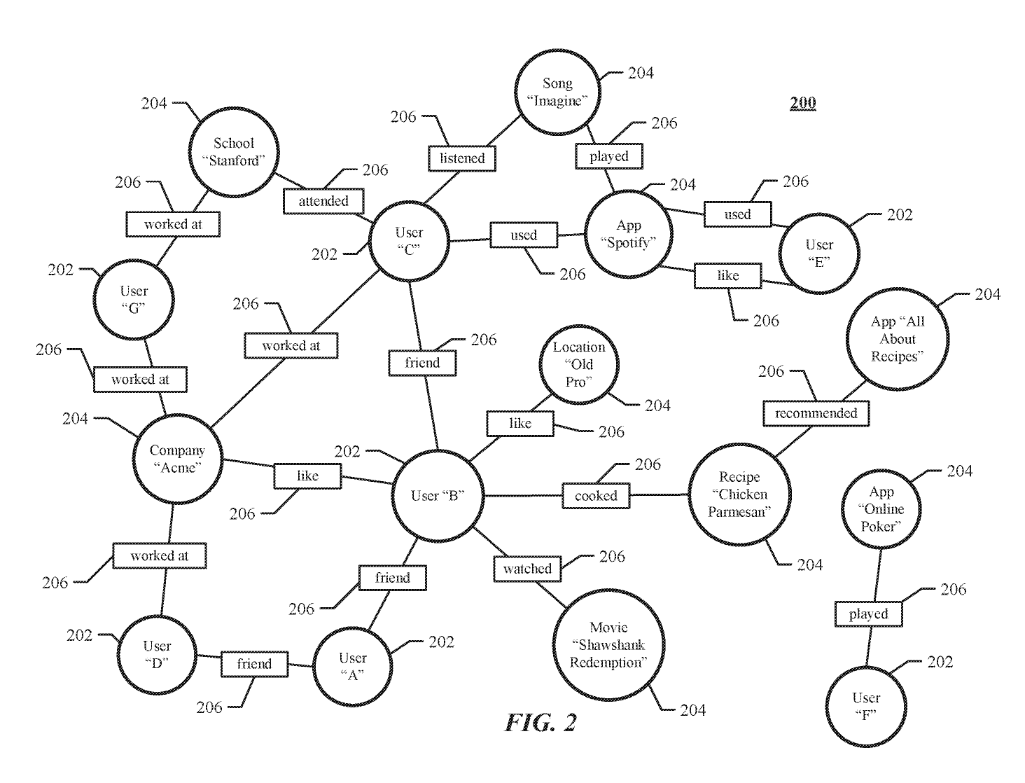

FIG. 2 illustrates an example social graph 200. In particular embodiments, the social-networking system 160 may store one or more social graphs 200 in one or more data stores. In particular embodiments, the social graph 200 may include multiple nodes—which may include multiple user nodes 202 or multiple concept nodes 204—and multiple edges 206 connecting the nodes. The example social graph 200 illustrated in FIG. 2 is shown, for didactic purposes, in a two-dimensional visual map representation. In particular embodiments, a social-networking system 160, a client system 130, or a third-party system 170 may access the social graph 200 and related social-graph information for suitable applications. The nodes and edges of the social graph 200 may be stored as data objects, for example, in a data store (such as a social-graph database). Such a data store may include one or more searchable or queryable indexes of nodes or edges of the social graph 200.

In particular embodiments, a user node 202 may correspond to a user of the social-networking system 160. As an example and not by way of limitation, a user may be an individual (human user), an entity (e.g., an enterprise, business, or third-party application), or a group (e.g., of individuals or entities) that interacts or communicates with or over the social-networking system 160. In particular embodiments, when a user registers for an account with the social-networking system 160, the social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system 160. In particular embodiments, a user node 202 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more web interfaces.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more web interfaces.

In particular embodiments, a node in the social graph 200 may represent or be represented by a web interface (which may be referred to as a “profile interface”). Profile interfaces may be hosted by or accessible to the social-networking system 160. Profile interfaces may also be hosted on third-party websites associated with a third-party system 170. As an example and not by way of limitation, a profile interface corresponding to a particular external web interface may be the particular external web interface and the profile interface may correspond to a particular concept node 204. Profile interfaces may be viewable by all or a selected subset of other users. As an example and not by way of limitation, a user node 202 may have a corresponding user-profile interface in which the corresponding user may add content, make declarations, or otherwise express himself or herself. As another example and not by way of limitation, a concept node 204 may have a corresponding concept-profile interface in which one or more users may add content, make declarations, or express themselves, particularly in relation to the concept corresponding to concept node 204.

In particular embodiments, a concept node 204 may represent a third-party web interface or resource hosted by a third-party system 170. The third-party web interface or resource may include, among other elements, content, a selectable or other icon, or other inter-actable object (which may be implemented, for example, in JavaScript, AJAX, or PHP codes) representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 202 corresponding to the user and a concept node 204 corresponding to the third-party web interface or resource and store edge 206 in one or more data stores.

In particular embodiments, a pair of nodes in the social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 206 connecting the first user's user node 202 to the second user's user node 202 in the social graph 200 and store edge 206 as social-graph information in one or more of data stores 164. In the example of FIG. 2, the social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to an edge type or subtype. A concept-profile interface corresponding to a concept node 204 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, the social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, the social-networking system 160 may create an edge 206 between a user node 202 and a concept node 204 in the social graph 200. As an example and not by way of limitation, a user viewing a concept-profile interface (such as, for example, by using a web browser or a special-purpose application hosted by the user's client system 130) may indicate that he or she likes the concept represented by the concept node 204 by clicking or selecting a “Like” icon, which may cause the user's client system 130 to send to the social-networking system 160 a message indicating the user's liking of the concept associated with the concept-profile interface. In response to the message, the social-networking system 160 may create an edge 206 between user node 202 associated with the user and concept node 204, as illustrated by “like” edge 206 between the user and concept node 204. In particular embodiments, the social-networking system 160 may store an edge 206 in one or more data stores. In particular embodiments, an edge 206 may be automatically formed by the social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

### Search Queries on Online Social Networks

In particular embodiments, the social-networking system 160 may receive, from a client system of a user of an online social network, a query inputted by the user. The user may submit the query to the social-networking system 160 by, for example, selecting a query input or inputting text into query field. A user of an online social network may search for information relating to a specific subject matter (e.g., users, concepts, external content or resource) by providing a short phrase describing the subject matter, often referred to as a “search query,” to a search engine. The query may be an unstructured text query and may comprise one or more text strings (which may include one or more n-grams). In general, a user may input any character string into a query field to search for content on the social-networking system 160 that matches the text query. The social-networking system 160 may then search a data store 164 (or, in particular, a social-graph database) to identify content matching the query. The search engine may conduct a search based on the query phrase using various search algorithms and generate search results that identify resources or content (e.g., user-profile interfaces, content-profile interfaces, or external resources) that are most likely to be related to the search query. To conduct a search, a user may input or send a search query to the search engine. In response, the search engine may identify one or more resources that are likely to be related to the search query, each of which may individually be referred to as a “search result,” or collectively be referred to as the “search results” corresponding to the search query. The identified content may include, for example, social-graph elements (i.e., user nodes 202, concept nodes 204, edges 206), profile interfaces, external web interfaces, or any combination thereof. The social-networking system 160 may then generate a search-results interface with search results corresponding to the identified content and send the search-results interface to the user. The search results may be presented to the user, often in the form of a list of links on the search-results interface, each link being associated with a different interface that contains some of the identified resources or content. In particular embodiments, each link in the search results may be in the form of a Uniform Resource Locator (URL) that specifies where the corresponding interface is located and the mechanism for retrieving it. The social-networking system 160 may then send the search-results interface to the web browser 132 on the user's client system 130. The user may then click on the URL links or otherwise select the content from the search-results interface to access the content from the social-networking system 160 or from an external system (such as, for example, a third-party system 170), as appropriate. The resources may be ranked and presented to the user according to their relative degrees of relevance to the search query. The search results may also be ranked and presented to the user according to their relative degree of relevance to the user. In other words, the search results may be personalized for the querying user based on, for example, social-graph information, user information, search or browsing history of the user, or other suitable information related to the user. In particular embodiments, ranking of the resources may be determined by a ranking algorithm implemented by the search engine. As an example and not by way of limitation, resources that are more relevant to the search query or to the user may be ranked higher than the resources that are less relevant to the search query or the user. In particular embodiments, the search engine may limit its search to resources and content on the online social network. However, in particular embodiments, the search engine may also search for resources or contents on other sources, such as a third-party system 170, the internet or World Wide Web, or other suitable sources. Although this disclosure describes querying the social-networking system 160 in a particular manner, this disclosure contemplates querying the social-networking system 160 in any suitable manner.

### Identifying Qualifying Keywords for an Online Marketing Campaign

In particular embodiments, the social-networking system 160 may identify keywords to use in a search engine marketing campaign on a third-party advertising service such as GOOGLE ADWORDS. The social-networking system 160 may receive many (e.g., 500 million) search queries every day. Search queries performed by users on the online social network may mirror search queries on third-party search engines such as GOOGLE. As an example and not by way of limitation, a spike in search traffic for a particular keyword (e.g., “jason paige”) may exist on both the social-networking system 160 and a third-party search engine on the same day. The social-networking system 160, along with the vast majority of other advertisers, may not have full access to the (external) search data of the third-party search engine, but the social-networking system 160 may have access to its own search data. Thus, the social-networking system 160 may use the half-billion searches performed on its own website to approximate (or, in particular embodiments, predict) the search queries occurring on a third-party search engine. The social-networking system 160 may use its own (internal) search data to identify qualifying keywords before the competition (e.g., other companies who wish to advertise on search-results pages for the same keywords). The social-networking system 160 may then bid on those qualifying keywords using an online-advertising service (e.g., GOOGLE ADWORDS). Other advertisers may be unaware that the qualifying keywords have relatively high search volume because they do not have access to a large amount of search data like the social-networking system 160 does. Thus, there may be low competition for qualifying keywords. Because there is low competition, qualifying keywords may be less expensive than other high-volume keywords. The system and method described herein may minimize interactions between the social-networking system and third-party online advertising services. This may decrease processing time on each party's respective servers as well as save memory space on each party's respective servers. Additionally, because the social-networking system uses internal search traffic data, the method and system described herein reduce latency between spikes in search traffic for various search terms and placing bids for those search terms. Another technical advantage of particular embodiments described herein may be to reduce the time required for monitoring third-party systems associated with external search engines. Instead of regularly sending requests for search data to a third-party system that produces search data analytics (e.g., GOOGLE TRENDS), the social-networking system may simply monitor its own internal search data and interact with a third-party system only when qualifying keywords are identified.

In particular embodiments, the social-networking system 160 may identify keywords that have relatively high search volume but low competition. Such keywords may be referred to as “qualifying keywords.” The social-networking system 160 may place advertisements on search-results pages for qualifying keywords at a relatively cheap price. One way to discover these keywords may be to identify less popular keywords whose search traffic spikes briefly (e.g., for a few days or weeks), and then goes down to its previous level. This strategy may be effective because the social-networking system may use internal search trends to identify keyword search traffic spikes more quickly than other advertisers, and thus place low bids (e.g., $0.10 per click) on keywords that most advertisers are unaware of, but that nevertheless have relatively high search volume (or are about to experience high search volume). This way, the advertisements placed by the social-networking system 160 may receive a relatively large number of impressions for a relatively inexpensive price. To identify qualifying keywords, the social-networking system 160 may access its internal search traffic data for many different keywords. The search traffic data for a particular keyword may contain information related to the search queries for that keyword, including search volume, geographic location of search queries, time-of-day/week/month/year a particular term is searched, social networking information related to the querying user (e.g., information stored in the social graph 200 maintained by the online-social network 160), and any other suitable information. As an example and not by way of limitation, search traffic data for the keyword “mortgage calculator” may indicate that on a given day, users of the online social networked inputted “mortgage calculator” as a search query 15,458 times. The number of searches that occur for a particular search term during a specified time period (e.g., one hour, one day, one week, one month) may be referred to as search volume. Thus, the search volume for “mortgage calculator” for a given day may be 15,458 searches. The search traffic data may also indicate the search volume over a period of time, such as the past 30 days, or any other suitable amount of time. The social-networking system 160 may then analyze the search traffic data for each keyword to identify qualifying keywords whose search traffic data meets one or more of the following criteria: (1) a current search volume for the qualifying keyword is less than an upper threshold volume; (2) an overall rate of change in search volume during an overall timeframe is greater than a first threshold rate of change; and (3) a current rate of change in search volume during a current timeframe is greater than a second threshold rate of change. The social-networking system may identify many qualifying keywords that meet the above criteria. For each qualifying keyword, the social-networking system may send instructions for placing a bid on the qualifying keyword to a third-party system associated with an external search engine (e.g., GOOGLE ADWORDS). Although this disclosure describes identifying qualifying keywords for use in an online marketing campaign in a particular manner, this disclosure contemplates identifying qualifying keywords for use in an online marketing campaign in any suitable manner.

Background on Search Engine Marketing

An online-advertising service like Google AdWords enables advertisers to compete to display advertisements on a search-results page. Advertisers create advertisements and then assign those advertisements to one or more keywords. Advertisements appear on the search-results page in response to a user entering particular keywords into a query field. As an example and not by way of limitation, if a user enters the query “Mother's Day Flowers” into a search engine query field, the search-results page may display an advertisement for 1-800-FLOWERS near the list of search-results. When a user selects the advertisement, the user is taken to the advertiser's website.

The online-advertising service (e.g., Google Adwords) uses an algorithm to identify and rank advertisements to display on a search-results page in response to a user inputting one or more keywords in a search engine query field. One input to the algorithm is the bid amount that the advertiser sets for the particular keyword. The bid amount may be structured as pay-per-click (PPC). As an example and not by way of limitation, 1-800-FLOWERS may set a bid amount of $0.50 for the keyword “flowers.” Every time a user inputs “flowers” in the search engine query field and clicks on the 1-800-FLOWERS advertisement on the resulting search-results page, 1-800-FLOWERS pays the search engine $0.50. The algorithm returns a ranking score for each advertisement based on the bid amount and various other factors (e.g., click-through rate). All else being equal, advertisements with a higher bid amount for a given keyword are ranked higher than advertisements with a lower bid amount. Keywords that have high search volume are usually more expensive than low-volume keywords because popular keywords have many more impressions than low-volume keywords. For example, the term “Lady Gaga” has much higher search volume than the term “Anika Moa” (both are female singers/songwriters). Thus, it is more expensive to advertise on a search results page for “Lady Gaga” than for “Anika Moa.” This may be because there is high competition for “Lady Gaga”—advertisers know that many people search “Lady Gaga.” Thus, advertisers are willing to pay more so that their advertisements are seen by more people. Lots of competition drives up the price for popular keywords.

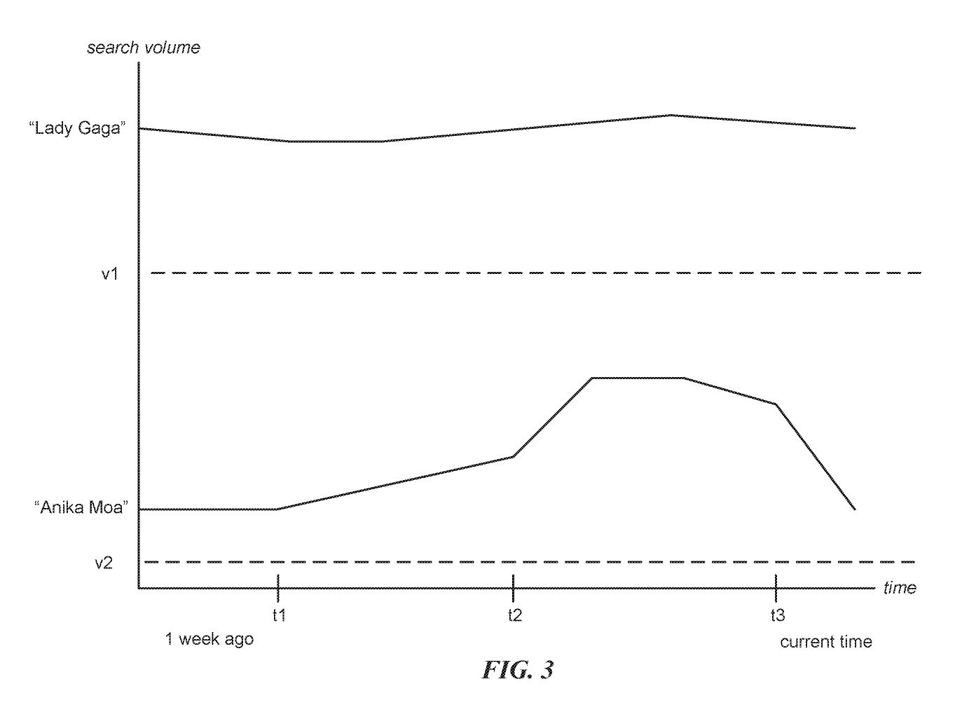

FIG. 3 illustrates an example search volume visualization for two example keywords: “Lady Gaga” and “Anika Moa.” The example search volume visualization may illustrate various aspects of the internal search traffic data of the social-networking system 160. The x-axis on the visualization may represent time in days, hours, weeks, or any other suitable time period. The y-axis may represent the search volume (e.g., the number of searches) for each of the keywords. The search volume on the online social network for “Lady Gaga” may be much higher than the search volume for “Anika Moa.” As an example and not by way of limitation, on a given day, the search volume for “Lady Gaga” may be 68,955 searches, and the search volume for “Anika Moa” may be 6,728. Thus, the search volume for “Lady Gaga” may be approximately ten times higher than the search volume for “Anika Moa.” It may be assumed that the search traffic data for these two keywords on the online social network may be similar to the search traffic data for these two keywords on third-party search engine, such as GOOGLE, if not in absolute number than at least in proportion. That is, the search volume on third-party search engine for “Lady Gaga” may be ten times higher than the search volume for “Anika Moa.” Although the social-networking system 160 may not know the exact data for terms searched on third-party search engines, it may use its own internal search traffic data to approximate search traffic on third-party search engines. The visualization may indicate one or more differences in search volume for various search terms. As an example and not by way of limitation, at time t1 in FIG. 3, the search volume for “Anika Moa” may begin to rise. At time t2, the search volume may begin to rise at a different rate. At time t3, the search volume for “Anika Moa” may begin to fall. Although this disclosure describes illustrating an example search volume visualization in a particular manner, this disclosure contemplates illustrating an example search volume visualization in any suitable manner.

Accessing Search Traffic Data

In particular embodiments, the social-networking system 160 may access internal search traffic data for a plurality of search queries input by users of the online social network. The internal search traffic data may comprise historical search volume on the online social network for each of a plurality of n-grams. N-grams, in this context, may also be referred to as search terms. Historical search volume may be understood to mean the number of searches that occurred for a particular search term during some previous time period. In particular embodiments, internal search traffic data may comprise other information for a particular search term in addition to historical search volume, such as one or more geographic locations where the search queries originate from, social networking information about the users who input the search term, and other relevant data, and may be filterable by any suitable filter. As an example and not by way of limitation, the internal search traffic data may be filtered by location so that the historical search volume from particular locations (e.g., Los Angeles, Calif.; India; South America) is visible. This way the social-networking system 160 may make more targeted online advertising campaigns. In particular embodiments, the social-networking system 160 may access search traffic data for all search terms entered by users of the online social network. Alternatively, the social-networking system 160 may access search traffic data for only the n-most frequent search terms, where n is an integer such as 100,000. A given search term may be associated with search traffic data, which may provide information about that search term, such as search volume over various periods of time, the geographic location from which the search term is input, and social networking information about users who input the given search term. As an example and not by way of limitation, the social-networking system 160 may access internal search traffic data associated with the search term “pupper squish.” The internal search traffic data may comprise the daily search volume of “pupper squish” on the online social network over the last thirty days (or any other suitable amount of time). The internal search traffic data may also comprise data indicating that 50% of search queries containing the n-gram “pupper squish” originate from the southwest region of the United States, and that 25% of users who searched for “pupper squish” on the online social network also interacted with (e.g., liked, viewed, shared) content related to the dog breed Shiba Inu. The internal search traffic data may also indicate which users interacted with content related to the dog breed Shiba Inu. Although this disclosure describes accessing internal search traffic data for a plurality of search queries in a particular manner, this disclosure contemplates accessing internal search traffic data for a plurality of search queries in any suitable manner.

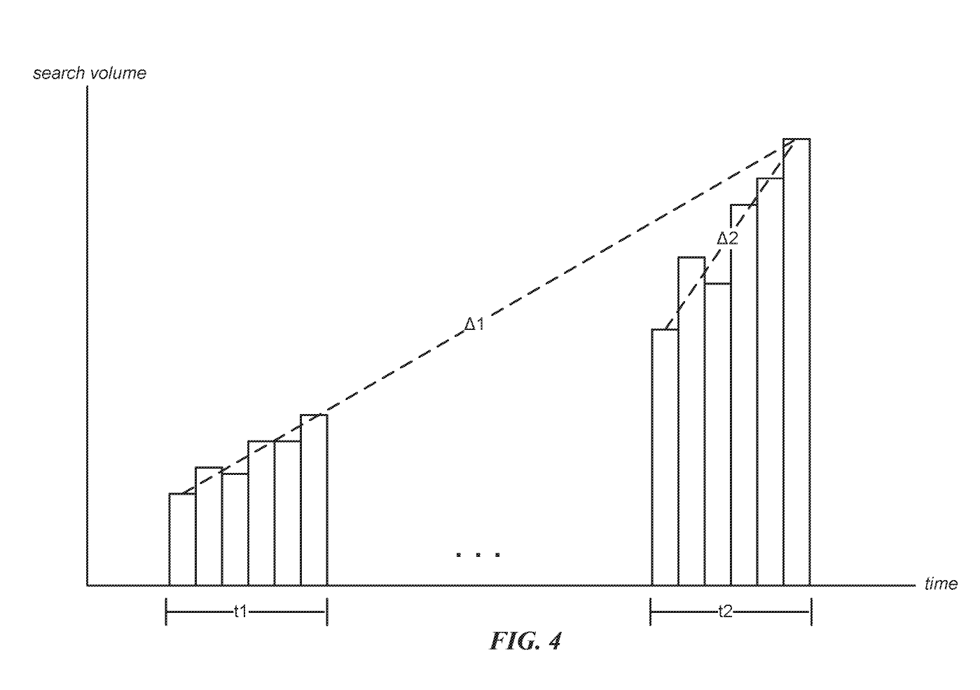

In particular embodiments, the historical search volume may be illustrated at least in part by a histogram of the frequency over time a given n-gram has been searched by users of the online social network. Such a histogram may be similar to the histogram illustrated by FIG. 4. The histogram may comprise a plurality of rectangles, wherein each rectangle may represent the number of searches performed by users on the online social network during a particular time period (e.g., one hour, one day) for a given keyword. As an example and not by way of limitation, the historical search volume for the keyword “dratini” may be illustrated as a histogram, where each rectangle of the histogram represents the number of searches performed by users on the online social network during a period of one day. The histogram may have thirty, sixty, or any suitable number of rectangles, which may represent the search volume for each day during a thirty-day, sixty-day, or any suitable numbered day period, respectively. Although this disclosure describes illustrating historical search volume in a particular manner, this disclosure contemplates illustrating historical search historical search volume in any suitable manner.

In particular embodiments, the search queries may comprise may a plurality of n-grams that correspond to a plurality of entities associated with the online social network. Each of these entities may correspond to a node on the social graph 200 of the online social network. As discussed previously, the social graph 200 may include multiple nodes—which may include multiple user nodes 202 or multiple concept nodes 204—and multiple edges 206 connecting the nodes. The social-networking system 160 may receive a search query and link it to a node on the social graph 200 based on a variety of factors, which are discussed in greater detail in U.S. patent application Ser. No. 15/337,832, filed 31 Oct. 2016, which is incorporated by reference. The social-networking system 160 may analyze information related to the node (e.g., the age of the node) and use the information as another factor in determining whether the n-grams that link to the node constitute a qualifying keyword. As an example and not by way of limitation, the n-gram “dratini” in a given search query may link to a node corresponding to the entity Dratini, which is a Pokémon character. The node corresponding to Dratini may have been created three months ago, which may be relatively young for a node on the social graph 200. Because the node is relatively young, it may be a signal that Dratini may be trending on third-party search engines. In other words, “dratini” may be a relatively new search term among the general public but may nevertheless be popular among a particular demographic (e.g., teenage boys). On the other hand, if Dratini were an old node on the social graph 200, it may not be trending, because trending topics tend to be new. In particular embodiments, the n-grams comprised in the search term may constitute a keyword that it so new that it corresponds to an entity that does not have a corresponding node in the social graph 200, because a node has not yet been created for the particular entity. In this case, the keyword may be treated similarly to how a young node may be treated. Although this disclosure describes analyzing information related to nodes in a particular manner, this disclosure contemplates analyzing information related to nodes in any suitable manner.

Identifying Qualifying Keywords

In particular embodiments, the social-networking system 160 may identify qualifying keywords from the plurality of n-grams based on the internal search traffic data. For a keyword to become a qualifying keyword, the internal search traffic data for that keyword may need to indicate that the search volume for that keyword satisfies one or more of the following criteria: (1) a current search volume for the qualifying keyword is less than an upper threshold volume; (2) an overall rate of change in search volume during an overall timeframe is greater than a first threshold rate of change; and (3) a current rate of change in search volume during a current timeframe is greater than a second threshold rate of change, wherein the overall timeframe begins at a time preceding the current timeframe. A keyword may be a qualifying keyword if its historical search volume meets one, two, or all three of the above criteria. In particular embodiments, further criteria may be necessary for a keyword to be a qualifying keyword. Each of these criteria will be discussed with reference to FIGS. 3 and 4.

In particular embodiments, for a given keyword to be considered a qualifying keyword, the internal search traffic data for that keyword may need to indicate that the current search volume for the keyword is less than an upper threshold volume. This may be because the number of impressions for keywords whose search volume is above the upper threshold volume may be high, which may raise the bid price to an undesirably high level. As an example and not by way of limitation, with reference to FIG. 3, an upper threshold may be set at the search volume level indicated by v1. Thus, “Lady Gaga” may not meet this particular criterion because the search volume for “Lady Gaga” may be above the upper threshold volume. In particular embodiments, the criteria may further include a lower threshold volume v2. This may be because the social-networking system 160 may desire to have a minimum number of impressions for any advertisements they place on search-results pages. If a keyword is below the lower threshold volume, there may be too few people searching for that keyword to make placing an advertisement on a search-results page for that keyword worth the cost of the bid for that keyword. Thus, the social-networking system 160 may pass over keywords whose search volume is below a lower threshold volume. As an example and not by way of limitation, the keyword “Anika Moa” may be both below the upper threshold volume and above the lower threshold volume. Thus, “Anika Moa” may satisfy the first criterion. Although this describes identifying a qualifying keyword in a particular manner, this disclosure contemplates identifying a qualifying keyword in any suitable manner.

In particular embodiments, for a given keyword to be considered a qualifying keyword, an overall rate of change in search volume for the keyword during an overall timeframe may need to be greater than a first threshold rate of change. The overall timeframe may be any suitable time period (e.g., the previous ten days). Generally, the overall timeframe may begin at some point in the past (e.g., one week before the current timeframe), and may end at the present time. However, the overall timeframe may both begin and end in the past (e.g., the overall timeframe may begin two weeks ago and end one week ago). The overall rate of change may be calculated by dividing the difference in search volume from the beginning of the overall timeframe and the end of the overall timeframe by the period of the overall timeframe. As an example and not by way of limitation, with reference to FIG. 3, the overall timeframe may span from time=t1 to time=t3. Thus, the overall rate of change mₒᵥₑᵣₐₗₗ may be expressed as:

$${m}_{overall} = \frac{( search volume at t 3 ) - ( search volume at t 1 )}{t 3 - t 1} .$$

As an example and not by way of limitation, the search volume at time=t1 for the keyword “Anika Moa” may be 5,244, and the search volume at time=t3 for the same keyword may be 12,976. The time between t1 and t3 may be ten days. Thus, the overall rate of change may be mₒᵥₑᵣₐₗₗ=(12,976−5,244)/10=773.2 searches per day. The formula may indicate that the search volume for “Anika Moa” has increased at a rate of 773.2 searches per day over the last 10 days. If the first threshold rate of change is 500 searches per day, then the keyword “Anika Moa” may satisfy the second criterion. Although this describes identifying a qualifying keyword in a particular manner, this disclosure contemplates identifying a qualifying keyword in any suitable manner.

FIG. 4 illustrates another example search volume visualization for an example keyword. In this example search volume visualization, the search volume may be represented by rectangles. Each rectangle may represent the number of searches performed by users on the online social network during the timeframe represented by the width of the rectangle, which may be any suitable timeframe, such as a minute, hour, day, or longer. In this particular example, the overall timeframe may span from the beginning of t1 until the end of t2. The overall rate of change may be Δ1. If Δ1 is greater than the first threshold rate of change, the keyword may satisfy the second criterion. As an example and not by way of limitation, a keyword may be “zombie honkpocalypse,” whose historical search volume may be partially displayed by the histogram illustrated in FIG. 4. Each rectangle in the histogram may represent the number of searches that occurred during a one hour period. The overall timeframe may span from the beginning of t1 until the end of t2. The search volume at the beginning of t1 (e.g., the number of searches during the first hour) for the keyword “zombie honkpocalypse” may be 3,356, and the search volume at the end of t2 for the same keyword may be 8,557. The time between the beginning of t1 and the end of t2 may be 136 hours. Thus, the overall rate of change may be mₒᵥₑᵣₐₗₗ=(8,557−3,356)/136 hours=38.2 searches per hour. The formula may indicate that the search volume for “zombie honkpocalypse” has increased at a rate of 38.2 searches per hour over the last 136 hours. If the first threshold rate of change is 20 searches per hour, then the keyword “zombie honkpocalypse” may satisfy the second criterion. Although this describes identifying a qualifying keyword in a particular manner, this disclosure contemplates identifying a qualifying keyword in any suitable manner.

In particular embodiments, for a given keyword to be considered a qualifying keyword, a current rate of change in search volume during a current timeframe may need to be greater than a second threshold rate of change. The second threshold rate of change may be greater than, less than, or equal to the first threshold rate of change. With reference to FIG. 4, the current rate of change may be represented by Δ2, which may indicate the increase in search volume during the time t2, which, in this example, may represent the current timeframe. The current timeframe may comprise an immediately preceding period of time, such as the last minute, hour, or day. As an example and not by way of limitation, if each rectangle in FIG. 4 represents the search volume for a given keyword during an hour of time, the current timeframe may be the previous six hours. If each rectangle represents the search volume for a given keyword during a minute of time, the current timeframe may be the previous six minutes. Any suitable timeframe may be used for the rectangles, even seconds. Additionally, any suitable number of rectangles may be used to determine the current timeframe. Two rectangles may need to be the minimum number of rectangles because two data points may be necessary to calculate a rate of change over time. Likewise, the current rate of change may not be an instantaneous rate of change, but may rather be the rate of change over an immediately preceding period of time, such as the last hour. Continuing with the above example for “zombie honkpocalypse,” the current rate of change may be represented by Δ2 in FIG. 4. The search volume at the beginning of t2 (e.g., the number of searches during the first hour of t2) for the keyword “zombie honkpocalypse” may be 4,017, and the search volume at the end of t2 may be 8,557. The time between the beginning of t2 and the end of t2 may be 6 hours. Thus, the current rate of change may be m_{current}=(8,557−4,017)/6 hours=756 searches per hour. The formula may indicate that the search volume for “zombie honkpocalypse” has increased at a rate of 756 searches per hour over the last 6 hours. If the second threshold rate of change is less than 756 searches per hour, then the keyword “zombie honkpocalypse” may satisfy the third criterion. Although this describes identifying a qualifying keyword in a particular manner, this disclosure contemplates identifying a qualifying keyword in any suitable manner.

In particular embodiments, a given keyword may have been a qualifying keyword in the past (e.g., the keyword “tiny arduino arcade” may have been a qualifying keyword two years ago). The qualifying keyword may have been used in an online marketing campaign by the social-networking system 160. The qualifying keyword may have had a conversion rate during the online marketing campaign. A conversion rate may be understood to mean a click-through-rate, a sign-up rate (e.g., when a non-user becomes a user of the online social network by creating a profile, that may be considered a “sign-up”), or any other suitable metric measure by the social-networking system 160. If a keyword meets one or more of the above discussed criteria a second time, the social-networking system 160 may also consider the historical conversion rate for that keyword. For that keyword to become a qualifying keyword, the historical conversion rate for that keyword may need to be greater than a threshold conversion rate. As an example and not by way of limitation, “tiny arduino arcade” may have been a qualifying keyword in the past and may have been used in an online marketing campaign by the social-networking system 160. The conversion rate for “tiny arduino arcade” may have been 0.001%, which may be too low to be worth the investment in the marketing campaign. The threshold conversion rate may be 0.05%. Because the historical conversion rate for “tiny arduino arcade” is below the threshold conversion rate, it may not be a qualifying keyword, even though it meets one or more of the other criteria for qualifying keywords. In particular embodiments, if the historical conversion rate for a particular keyword is relatively high, the other criteria may be adjusted so that the keyword may become a qualifying keyword. As an example and not by way of limitation, if “tiny arduino arcade” has a historical conversion rate of 10%, this may be relatively high. Thus, the social-networking system may adjust various thresholds up or down so that “tiny arduino arcade” may become a qualifying keyword. For example, the social-networking system 160 may raise the upper threshold volume, lower the first or second threshold rates of change, or make any other suitable adjustment. Although this disclosure describes identifying a qualifying keyword in a particular manner, this disclosure contemplates identifying a qualifying keyword in any suitable manner.

In particular embodiments, the social-networking system 160 may filter out particular keywords that meet one or more of the criteria discussed herein but whose historical search volume follows a periodic pattern. Historical search volume may follow a periodic pattern when a histogram representation of the historical search volume substantially repeats itself on a regular basis. As an example and not by way of limitation, the historical search volume for the keyword “TGIF” may spike every Friday. Other keywords that may be subject to periodic patterns include “throwback Thursday” and “flashback Friday.” Although such keywords may have historical search volume that meets the criteria discussed herein, these keywords may be unsuitable keywords for the purpose of an online advertising campaign. The social-networking system 160 may recognize and filter out keywords that have weekly periodic patterns, monthly periodic patterns, yearly periodic patterns, or any other suitable periodic pattern. To recognize such keywords, the social-networking system 160 may analyze the historical search volume of a given keyword during a previous timeframe (e.g., the past year, two years, six months, one month) and determine whether the historical search volume has crests or troughs at regular intervals. If so, the keyword may be deemed to be following a periodic pattern and may be unsuitable as a qualifying keyword. Although this disclosure describes identifying and filtering particular keywords in a particular manner, this disclosure contemplates identifying and filtering particular keywords in any suitable manner.

Sending Instructions for Bidding on Keywords

In particular embodiments, once the social-networking system 160 has identified several qualifying keywords, it may send instructions for placing a bid on each qualifying keyword to a third-party system associated with an external search engine. This third-party system may be any suitable system such as GOOGLE ADWORDS, or any other online advertising service. As an example and not by way of limitation, the social-networking system 160 may identify 100 keywords whose search traffic data meets at least the criteria described herein. Therefore these 100 keywords may be considered qualifying keywords. For each qualifying keyword, the social networking system 160 may automatically place a bid for that keyword with an online advertising service. The bid may have a price that may be any suitable price (e.g., $0.10). As an example and not by way of limitation, if a qualifying keyword is “Begonia Chinese,” the social networking system 160 may place a bid of $0.10 for “Begonia Chinese,” with an online advertising service such as GOOGLE ADWORDS. This may result in an advertisement being placed on a search-results page for “Begonia Chinese” that was performed by a search engine associated with the online advertising service (e.g., GOOGLE). Every time a person enters “Begonia Chinese” in a query field associated with the search engine and then selects the advertisement placed by the social-networking system 160, the social-networking system 160 may be required to pay the search engine $0.10. This is a PPC arrangement. In particular embodiments, the sum of bids for the plurality of qualifying keywords may be less than a current price per click for any keyword with a current search volume greater than the upper threshold volume. As an example and not by way of limitation, the keyword “mortgage calculator” may have been the eighteenth most popular non-brand search term in 2015. Over 3.25 million people may search “mortgage calculator” per month. Because it is such a popular keyword, it may be expensive to place advertisements on search-results pages for that keyword. It may cost an advertiser $5.00 on a PPC structure to place an advertisement on the front page of search-results associated with “mortgage calculator.” In contrast, following ten keywords may be less popular: “Jason Paige,” “Pete Mel,” “pupper squish,” “Halifax Police Department,” “Begonia Chinese,” “surfing white tiger,” “zombie honkpocalype,” “Monterey Bay Sailing,” “Andrew Benintendi,” and “Dratini.” Each of these keywords may receive 1/10th of the search volume that “mortgage calculator” receives, but may cost less than 1/10th (e.g., 1/50th) as much to advertise on search results pages associated with these keywords. For example, to place an advertisement on a search results page for the keyword “Dratini,” it may only cost the advertiser $0.10 per click. If all of the above listed less-popular keywords are qualifying keywords, bidding on these less popular keywords may allow the social-networking system 160 to place its advertisements in front of just as many people as if it had placed a bid on “mortgage calculator,” but at a lower cost. Although this disclosure describes sending instructions for placing a bid on qualifying keywords in a particular manner, this disclosure contemplates sending instructions for placing a bid on qualifying keywords in any suitable manner.

In particular embodiments, the instructions for each qualifying keyword may be sent periodically until the current search volume for the qualifying keyword drops below a lower threshold volume. As discussed previously, the social-networking system 160 may desire to have a minimum number of impressions for any advertisements it places on search-results pages. If a keyword is below the lower threshold volume, there may be too few people searching for that keyword to make placing an advertisement on a search-results page for that keyword worth the cost of the bid for that keyword. Thus, the social-networking system 160 may discontinue sending instructions to bid on a keyword whose current search volume has dropped below a lower threshold volume. In particular embodiments, the current search volume may not be used as the metric. This is because the current search volume may fluctuate depending on various factors such as the time of day. Instead, another timeframe may be used to determine whether the social-networking system 160 should stop sending instructions to place a bid for a particular keyword. Any suitable timeframe may be appropriate, such as a week or 10 days. The same analysis may be applied for other metrics, such as the current rate of change in search volume or the bid price for the keyword. Once the current rate of change for a given keyword in search volume drops below a threshold rate of change for a particular amount of time, the social-networking system 160 may stop sending instructions to place a bid for the keyword. This may be seen with reference to FIG. 3. The search volume for “Anika Moa” after time=t3 may be decreasing at such a fast rate, that the social-networking system may stop sending instructions to place a bid on “Anika Moa,” even though the search volume may be above the threshold level. Likewise, if the bid price becomes too high (e.g., 51.50 per click), the social-networking system 160 may stop sending instructions to place a bid for “Anika Moa.” Although this disclosure describes sending instructions for placing a bid on qualifying keywords in a particular manner, this disclosure contemplates sending instructions for placing a bid on qualifying keywords in any suitable manner.

In particular embodiments, the bid may be associated with a bid price (e.g., $0.50 per click). The bid price may fluctuate depending on how popular the keyword associated with the bid is. The social-networking system 160 may determine how much to bid for each qualifying keyword. This determination may be made once for all qualifying keywords (e.g., bid $0.10 for every keyword), or the determination may be made periodically, and may take into consideration several factors, including the current search volume, the current rate of change in search volume, the particular keyword, whether the keyword is associated with a node in the social graph 200, whether the click-through rate for a particular advertisement and keyword combination is particularly high, or any other suitable factor. As an example and not by way of limitation, if the current search volume for a particular keyword is relatively high, the social-networking system 160 may increase the bid amount for that keyword. As another example and not by way of limitation, if the current rate of change in search volume for a particular keyword is relatively high, the social-networking system 160 may increase the bid amount for that keyword. As another example and not by way of limitation, if the keyword is “pete mel” (Pete Mel is a professional surfer), a node for the official Pete Mel fan page may exist on the social graph 200. When a person searches “pete mel” on a third-party search engine, the social-networking system 160 may wish to place an advertisement on the search-results page that says “Follow Pete Mel on Facebook. Sign up today,” or something similar. Thus, if a qualifying keyword may be associated with a node in the social graph 200, the social-networking system 160 may increase the bid amount for the qualifying keyword because it may be able to make a more targeted advertisement. As another example and not by way of limitation, if a click-through-rate for a particular advertisement is relatively high for a particular keyword, it may be an indication that the advertisement performs particularly well. Thus, the social-networking system 160 may increase the bid amount for that keyword, so that the advertisement receives more impressions and presumably more conversions. Although this disclosure describes adjusting bid amounts for keywords in a particular manner, this disclosure contemplates adjusting bid amounts for keywords in any suitable manner.

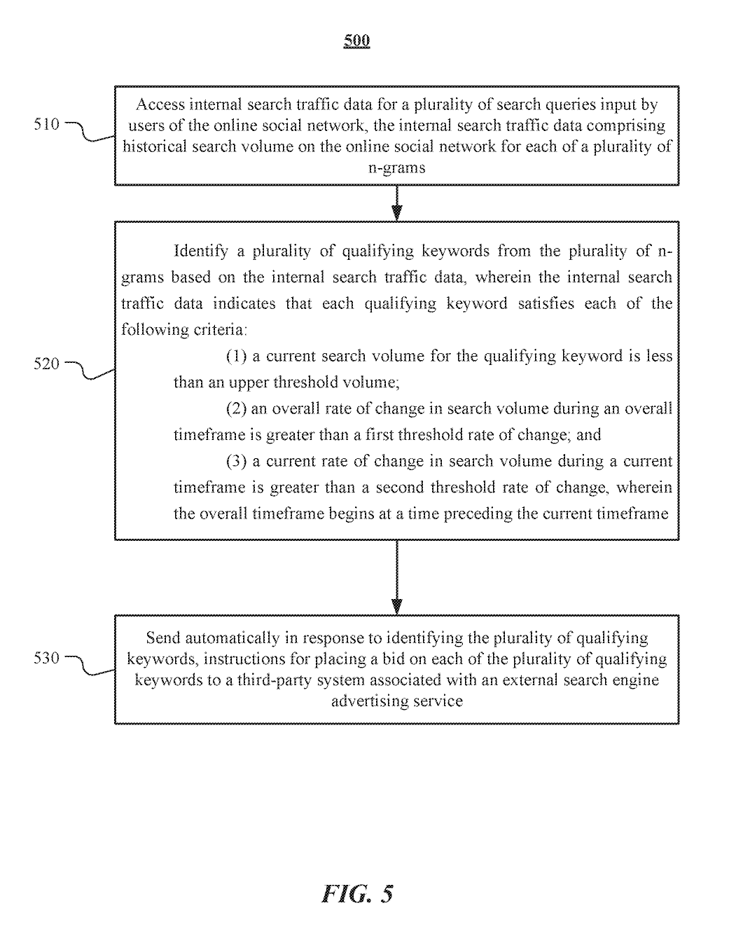

FIG. 5 illustrates an example method 500 for identifying qualifying keywords for use in an online marketing campaign. The method may begin at step 510, where the social-networking system 160 may access internal search traffic data for a plurality of search queries input by users of the online social network, the internal search traffic data comprising historical search volume on the online social network for each of a plurality of n-grams. At step 520, the social-networking system 160 may identify a plurality of qualifying keywords from the plurality of n-grams based on the internal search traffic data, wherein the internal search traffic data indicates that each qualifying keyword satisfies each of the following criteria: (1) a current search volume for the qualifying keyword is less than an upper threshold volume; (2) an overall rate of change in search volume during an overall timeframe is greater than a first threshold rate of change; and (3) a current rate of change in search volume during a current timeframe is greater than a second threshold rate of change, wherein the overall timeframe begins at a time preceding the current timeframe. At step 530, the social-networking system 160 may send automatically in response to identifying the plurality of qualifying keywords, instructions for placing a bid on each of the plurality of qualifying keywords to a third-party system associated with an external search engine. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for identifying qualifying keywords for use in an online marketing campaign including the particular steps of the method of FIG. 5, this disclosure contemplates any suitable method for identifying qualifying keywords for use in an online marketing campaign including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

### Advertising

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more web interfaces, in one or more e-mails, or in connection with search results requested by a user. In addition or as an alternative, an advertisement may be one or more sponsored stories (e.g., a news-feed or ticker item on the social-networking system 160). A sponsored story may be a social action by a user (such as “liking” an interface, “liking” or commenting on a post on an interface, RSVPing to an event associated with an interface, voting on a question posted on an interface, checking in to a place, using an application or playing a game, or “liking” or sharing a website) that an advertiser promotes, for example, by having the social action presented within a pre-determined area of a profile interface of a user or other interface, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results interface, where sponsored content is promoted over non-sponsored content.

In particular embodiments, an advertisement may be requested for display within social-networking-system web interfaces, third-party web interfaces, or other interfaces. An advertisement may be displayed in a dedicated portion of an interface, such as in a banner area at the top of the interface, in a column at the side of the interface, in a GUI within the interface, in a pop-up window, in a drop-down menu, in an input field of the interface, over the top of content of the interface, or elsewhere with respect to the interface. In addition or as an alternative, an advertisement may be displayed within an application. An advertisement may be displayed within dedicated interfaces, requiring the user to interact with or watch the advertisement before the user may access an interface or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) an interface associated with the advertisement. At the interface associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, the social-networking system 160 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through the social-networking system 160) or RSVP (e.g., through the social-networking system 160) to an event associated with the advertisement. In addition or as an alternative, an advertisement may include social-networking-system content directed to the user. As an example and not by way of limitation, an advertisement may display information about a friend of the user within the social-networking system 160 who has taken an action associated with the subject matter of the advertisement.

### Systems and Methods

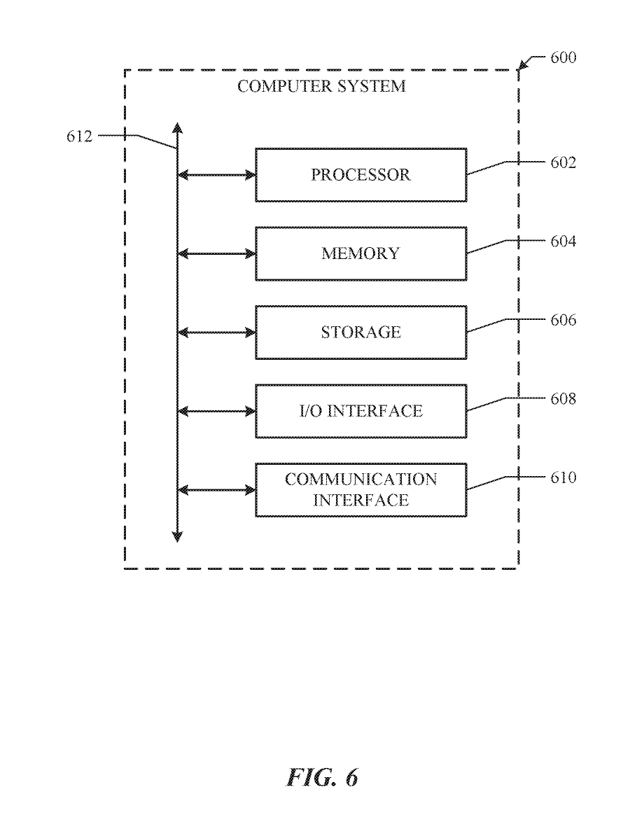

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### MISCELLANEOUS

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
accessing internal search traffic data for a plurality of search queries input by users of a communication system, the internal search traffic data comprising historical search volume on the communication system for each of a plurality of n-grams;
identifying a plurality of qualifying keywords from the plurality of n-grams based on the internal search traffic data, wherein the internal search traffic data indicates that a current search volume for the qualifying keyword is less than an upper threshold volume; and
sending, automatically in response to identifying the plurality of qualifying keywords, instructions for placing a bid on each of the plurality of qualifying keywords to a third-party system associated with an external search engine.

2. The method of claim 1, wherein the internal search traffic data for the qualifying keyword further indicates that an overall rate of change in search volume during an overall timeframe is greater than a first threshold rate of change, wherein the overall timeframe comprises time from at least one week prior to the current timeframe.

3. The method of claim 1, wherein the internal search traffic data for the qualifying keyword further indicates that a current rate of change in search volume during a current timeframe is greater than a second threshold rate of change, wherein the overall timeframe begins at a time preceding the current timeframe, and wherein the current timeframe comprises time from at least one hour prior to the current timeframe.

4. The method of claim 1, wherein the internal search traffic data for the qualifying keyword further indicates that the current search volume for the qualifying keyword is greater than a lower threshold volume.

5. The method of claim 1, wherein the internal search traffic data for the qualifying keyword comprises a past conversion rate for the qualifying keyword that is greater than a threshold conversion rate.

6. The method of claim 1, wherein each qualifying keyword is associated with a current price per click that is less than a threshold price per click.

7. The method of claim 6, wherein the threshold price is $0.10 USD per click.

8. The method of claim 1, wherein the historical search volume comprises a histogram of the frequency over time a given n-gram has been searched by users of the online social network.

9. The method of claim 1, wherein the search queries comprise a plurality of n-grams that correspond to a plurality of entities associated with an online social network associated with a social-networking system, respectively, the plurality of entities corresponding to a plurality of nodes, respectively, of a social graph of the online social network.

10. The method of claim 1, wherein the search queries comprise a plurality of n-grams, wherein one or more of the n-grams correspond to one or more entities associated with an online social network associated with a social-networking system, and wherein one or more of the n-grams do not correspond to entities associated with the online social network.

11. The method of claim 1, wherein a sum of qualifying keyword bids is less than a current price per click for any keyword with current search volume greater than the upper threshold volume.

12. The method of claim 1, wherein the instructions for each qualifying keyword are sent periodically until the current search volume for the qualifying keyword drops below a lower threshold volume or the current rate of change in search volume drops below a third threshold rate of change.

13. The method of claim 1, wherein the instructions for each qualifying keyword are sent periodically until the current rate of change in search volume is less than a third threshold rate of change.

14. The method of claim 1, wherein the instructions for each qualifying keyword are sent periodically until a price associated with the bid is above a threshold price.

15. The method of claim 1, further comprising determining, for each qualifying keyword, a bid amount for the bid for the qualifying keyword, wherein the bid amount is based on the overall rate of change or the current rate of change in search volume of the qualifying keyword.

16. The method of claim 1, further comprising increasing a bid amount for the bid for each qualifying keyword that is associated with a click-through-rate above a threshold click-through rate.

17. The method of claim 1, further comprising increasing a bid amount for the bid for each qualifying keyword that is related to an entity associated with the online social network.

18. The method of claim 1, wherein the communication system is a social-networking system and further comprising increasing a bid amount for the bid for each qualifying keyword that is related to an entity having a profile page on the social-networking system.

19. The method of claim 1, further comprising filtering the internal search traffic data to comprise only historical search volume performed by users in a particular geographic location.

20. One or more computer-readable non-transitory storage media embodying software that is operable when executed to:
access internal search traffic data for a plurality of search queries input by users of a communication system, the internal search traffic data comprising historical search volume on the communication system for each of a plurality of n-grams;
identify a plurality of qualifying keywords from the plurality of n-grams based on the internal search traffic data, wherein the internal search traffic data indicates that a current search volume for the qualifying keyword is less than an upper threshold volume; and
send, automatically in response to identifying the plurality of qualifying keywords, instructions for placing a bid on each of the plurality of qualifying keywords to a third-party system associated with an external search engine.

21. A system comprising: one or more processors; and a non-transitory memory coupled to the processors comprising instructions executable by the processors, the processors operable when executing the instructions to:
access internal search traffic data for a plurality of search queries input by users of a communication system, the internal search traffic data comprising historical search volume on the communication system for each of a plurality of n-grams;
identify a plurality of qualifying keywords from the plurality of n-grams based on the internal search traffic data, wherein the internal search traffic data indicates that a current search volume for the qualifying keyword is less than an upper threshold volume; and
send, automatically in response to identifying the plurality of qualifying keywords, instructions for placing a bid on each of the plurality of qualifying keywords to a third-party system associated with an external search engine.
